(19) United States
(12) Patent Application Publication
(10) Pub. No.: US 2020/0381171 A1
(43) Pub. Date: Dec. 3, 2020

(54) COIL DEVICE

(71) Applicant: HITACHI METALS LTD., Tokyo (JP)

(72) Inventor: Mutsuhito SAKAGUCHI, Tottori-shi, Tottori (JP)

(73) Assignee: HITACHI METALS LTD., Tokyo (JP)

(21) Appl. No.: 16/496,533

(22) PCT Filed: Mar. 23, 2018
(86) PCT No.: PCT/JP2018/011725

§ 371 Date: Sep. 23, 2019

(30) Foreign Application Priority Data
Mar. 27, 2017 (JP) 2017-061681

(51) Int. Cl. H01F 27/30; H01F 27/24; H01F 27/02; H01F 27/28

(52) U.S. Cl. CPC H01F 27/30; H01F 27/2823; H01F 27/02; H01F 27/24

(57) ABSTRACT

A coil device comprising a pair of coil members annularly assembled at two connecting end portions; each coil member comprising a magnetic core, a resin case substantially entirely surrounding the magnetic core, and a coil wound around the resin case; the resin case having connecting means and guide means in the connecting end portion of each coil member; and the connected coil members being adhered to each other in the connecting end portions.

### FIELD OF THE INVENTION

The present invention relates to a coil device used for transformers, reactors, choke coils, etc., particularly to an annularly assembled coil device.

### BACKGROUND OF THE INVENTION

Coil devices such as transformers, reactors, choke coils, etc. have conventionally been used in various applications such as home electric appliances, industrial appliances, vehicles, etc. A general coil device has a basic structure comprising a coil, an insulating resin bobbin around which the coil is wound, and a magnetic core arranged inside the bobbin.

The coil device has an annular structure as a whole, and the magnetic core constitutes a closed magnetic circuit. Among varied structures depending on the applications of the coil devices, some magnetic cores have annular structures constituted by assembling pluralities of divided members for easiness of winding wires around magnetic cores, etc.

For example, Japanese Utility Model Laid-Open Application 3-117820 discloses a rectangularly annular coil device constituted by assembling coil members each comprising a coil wound around an insulation case containing a magnetic core. FIG. 16 is a front view showing this coil device, with a partial cross section for easy understanding of the internal structure. FIG. 17 is a perspective view showing a coil member constituting the coil device.

The coil device comprises two assembled U-shaped magnetic cores 308 (308a, 308b). Each magnetic core 308 (308a, 308b) has a straight portion around which a coil is wound, and a bent portion extending in a direction crossing the longitudinal direction of the straight portion from both ends of the straight portion. The magnetic cores 308 (308a, 308b) are connected with their end surfaces 310 abutting each other to constitute the rectangularly annular magnetic core.

Each magnetic core 308 (308a, 308b) is received in each insulation case 301 (301a, 301b), and each coil 309a, 309b is wound around each case to constitute each coil member. The insulation case 301 (301a, 301b) has a partially opened hollow portion 311, in which the magnetic core 308 (308a, 308b) is received, with rear and side surfaces of the magnetic core 308 (308a, 308b) covered by the insulation case 301 (301a, 301b).

One insulation case 301b of the coil member has a projection 307 extending in the abutting direction, and the other insulation case 301a has a recess 306 for receiving the projection. The projection 307 comprises a thin-plate-shaped aim having a nail at its tip end, and the recess 306 acts as a fixing hole receiving the arm. Each insulation case 301 (301a, 301b) has a spring portion 315 pushing the magnetic core 308 (308a, 308b) toward the abutting surface 310.

With the nail at the tip end of the projection 307 engaging the fixing recess 306 to push the magnetic core 308 (308a, 308b) from rear toward the abutting surface 310, two coil members are integrally combined. Further, the coil members, the magnetic cores 308 (308a, 308b) and the insulation cases 301 (301a, 301b) are fixed by impregnation with varnish, to form the coil device.

Such structure can provide a coil device with easy coil winding and assembling. However, because the magnetic core is not entirely covered with the insulation case, high insulation is necessary between the coil and the magnetic core, when used for high-voltage, high-current reactors, etc.

Though the assembling of coil members is ensured by the engagement of the projections and recesses of the insulation cases, they are easily detached by an external force when not fixed by an adhesive such as varnish, etc., needing careful handling.

### OBJECT OF THE INVENTION

Accordingly, an object of the present invention is to provide a coil device constituted by annularly assembling divided magnetic cores, which has improved insulation between coils and magnetic cores, and easiness in handling because the assembled coil members are not easily detached before adhering.

### DISCLOSURE OF THE INVENTION

The present invention provides a coil device comprising a pair of annularly assembled coil members each comprising a coil arranged on a resin case containing a U-shaped magnetic core;

each of the coil members having connecting portions on both end sides of the magnetic core;

each of the connecting portions having a connecting part and a reinforcing part;

the reinforcing part being constituted by a gap between an inner wall of the resin case and an outer wall of the magnetic core, and a projection plate extending in the assembling direction of the coil members, a projection plate of one coil member being insertable into the gap of the other coil member; and

the connecting part comprising a hook-shaped projection extending in the assembling direction and a projection receiver, the hook-shaped projection of one coil member being loosely fittable into the projection receiver of the other coil member.

The connecting portion of each coil member preferably has the hook-shaped projection of the connecting part on one side of the magnetic core, and the projection receiver on the other side, when viewed in the assembling direction, and further has a projection plate of the reinforcing part on the side of the projection receiver of the connecting part, and the gap on the side of the hook-shaped projection of the connecting part.

The positional relation between the hook-shaped projection and projection receiver of the connecting part in one connecting portion of the coil member is 180° inverse to that in the other connecting portion.

When the coil members are assembled, abutting portions of the opposing magnetic cores are preferably surrounded by the projection plates of the reinforcing parts.

The hook-shaped projection of the connecting part preferably has two arms, each arm having a hook-shaped portion at its tip end.

The resin case is constituted by two assembled case members, each case member receiving the magnetic core in its bottomed space.

The resin case preferably has flanges for positioning the coil.

### EFFECT OF THE INVENTION

The present invention provides an easy-to-handle coil device constituted by annularly assembling divided magnetic cores to have improved insulation between coils and magnetic cores, whose coil members are not easily separated even before adhering.

### BRIEF DESCRIPTION OF THE DRAWINGS

FIG. 1(a) is a plan view showing an example of the coil devices of the present invention.

FIG. 1(b) is a front view showing an example of the coil devices of the present invention.

FIG. 2 is a perspective view showing an example of magnetic cores used in the coil device of the present invention.

FIG. 3 is a perspective view showing a coil member constituting the coil device of the present invention.

FIG. 4 is a right side view showing the coil member of FIG. 3 in a direction C.

FIG. 5 is a front view showing the coil member of FIG. 3 in a direction B.

FIG. 6 is a perspective view showing a first case member constituting a resin case used in the coil device of the present invention.

FIG. 7 is a bottom view showing the first case member of FIG. 6 in a direction A.

FIG. 8 is a right side view showing the first case member of FIG. 6 in a direction B.

FIG. 9 is a left side view showing the first case member of FIG. 6 in a direction C.

FIG. 10 is a front view showing the first case member of FIG. 6 in a direction D.

FIG. 11 is a perspective view showing a second case member constituting a resin case used in the coil device of the present invention.

FIG. 12 is a bottom view showing the second case member of FIG. 11 in a direction A.

FIG. 13 is a right side view showing the second case member of FIG. 11 in a direction B.

FIG. 14 is a left side view showing the second case member of FIG. 11 in a direction C.

FIG. 15 is a front view showing the second case member of FIG. 11 in a direction D.

FIG. 16 is a front view showing an example of conventional coil devices.

FIG. 17 is a perspective view showing a coil member constituting the conventional coil device.

### DESCRIPTION OF THE PREFERRED EMBODIMENTS

The coil device according to an embodiment of the present invention will be specifically explained below, though the present invention is not restricted thereto. In part or all of the figures, portions unnecessary for explanation are omitted, and some portions are expanded or shrunken for easy explanation. Sizes and shapes shown for explanation, the relative positions of constituent members, etc. are not restricted to those shown in the figures, unless otherwise mentioned. In the explanations, the same names and reference numerals indicate the same or similar members, and the detailed explanations of some of those depicted are omitted.

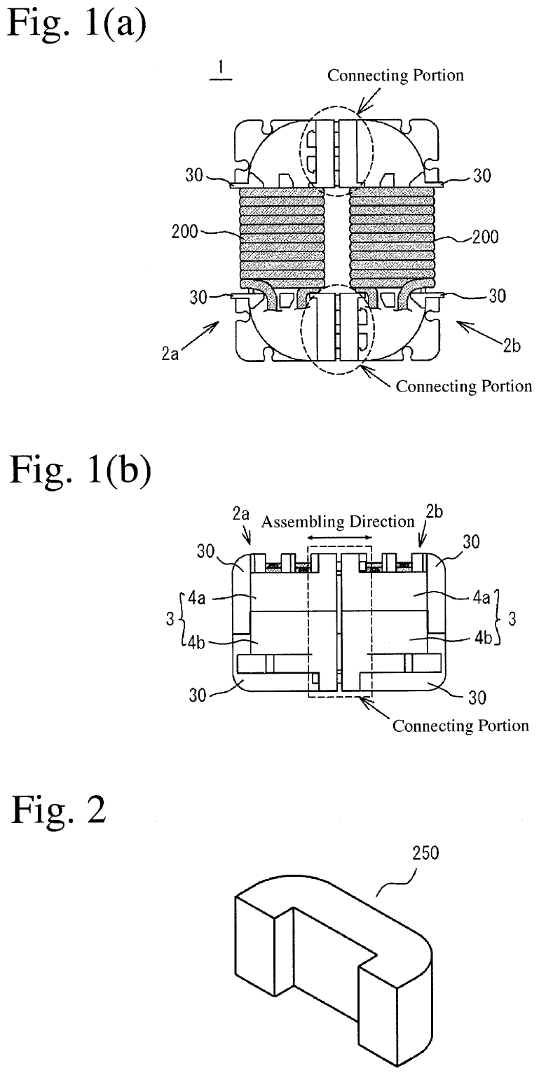

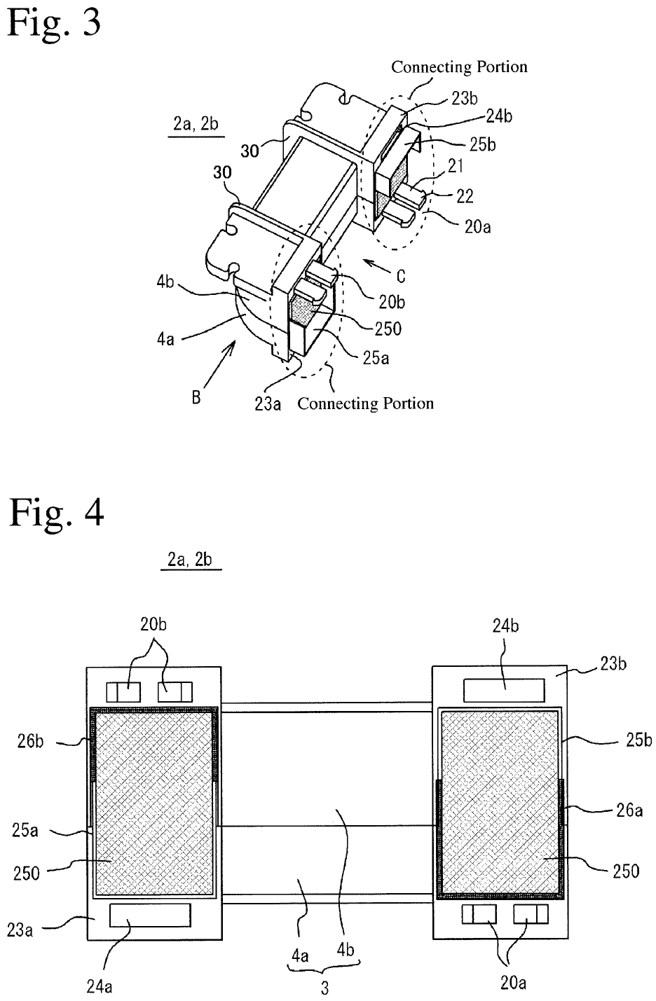

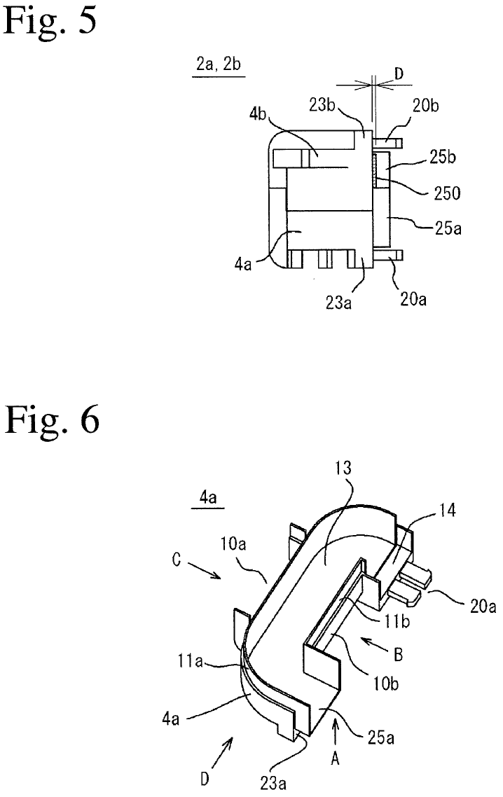

FIG. 1(a) is a plan view showing an appearance of the coil device, and FIG. 1(b) is its front view. FIG. 2 is a perspective view showing an example of magnetic cores used in the coil device. FIG. 3 is a perspective view showing a coil member, FIG. 4 is a right side view showing the coil member in a direction C, and FIG. 5 is a front view showing it in a direction B. Incidentally, a coil is omitted in FIGS. 3, 4 and 5.

The coil device 1 of the present invention is constituted by assembled coil members 2a, 2b. Each coil member 2a, 2b comprises a magnetic core 250, a resin case 3 entirely enclosing the magnetic core, and a coil 200 wound around the resin case 3, the coil members 2a, 2b being assembled with their two connecting portions abutting each other and fixed by an adhesive, to constitute a rectangularly annular coil device 1. The coil 200 is wound around a straight portion between flanges 30.

As shown in FIG. 3, the straight portion between the flanges 30 has chamfered corners for easy winding of the conductor wire without damage. Each end portion of the coil 200 extends through a notch of the flange 30.

The coil 200 may be constituted by a single conductor wire or a flat, rectangularly cross-sectional conductor wire, which is coated with insulating enamel, or a Litz wire formed by several tens to hundreds of twisted, enameled, thin copper wires to have an increased conductor surface area to reduce temperature elevation by increased resistance due to skin effect. Because the coil member 2a, 2b has a shape making the winding of a coil easy, the type and number of winding of a conductor wire in the coil 200 are not restrictive, but may be selected depending on applications.

Though details are described below, the resin case 3 is constituted by assembling two case members 4a, 4b, and each case member 4a, 4b has a U-shaped, bottomed space partially receiving the magnetic core 250. The magnetic core 250 is placed in a space defined by assembled case members 4a, 4b, and the coil members 2a, 2b are assembled with the end surfaces of one magnetic core 250 and the other magnetic core 250 opposing each other. The magnetic cores 250 are entirely covered by the resin cases 3 for improved insulation between the coil 200 and the magnetic core 250.

The magnetic core 250 is preferably a magnetic core of Mn— or Ni— soft ferrite, or a dust magnetic core of crystalline or amorphous alloys such as Fe—Si alloys, Fe—Cr alloys, Fe—Cr—Si alloys, Fe—Al alloys, Fe—Al—Si alloys, Fe—Al—Cr alloys, Fe—Al—Cr—Si alloys, Fe—Ni alloys, Fe—M—B alloys, etc.

Each coil member 2a, 2b has two connecting portions each comprising a connecting part and a reinforcing part, on both end sides of the U-shaped magnetic core 250. Each connecting part is constituted by hook-shaped projections 20a, 20b integral with the resin case 3 and projection receivers 23a, 23b. Each reinforcing part is constituted by a gap 26a, 26b defined by an inner surface of the resin case and the magnetic core, and a projection plate 25a, 25b integrally extending from the resin case 3 in the assembling direction of the coil members 2a, 2b.

The connecting part and the reinforcing part will be explained in detail referring to FIGS. 3-5.

Connecting Part

Each hook-shaped projection 20a, 20b comprises an aim portion 21 extending in the assembling direction of the coil members 2a, 2b, and a hook-shaped portion at a tip end of the arm portion 21. Each projection receiver 23a, 23b is a wall-like portion of the resin case projecting in a direction perpendicular to the assembling direction, which comprises a hollow portion 24a, 24b engageable with a corresponding hook-shaped projection 20a, 20b. To assemble the coil members 2a, 2b, the hook-shaped projection 20a is loosely fit into the projection receiver 23a, and the hook-shaped projection 20b is loosely fit into the projection receiver 23b. The hook-shaped tip portions 22 of the hook-shaped projections 20a, 20b are inserted into the hollow portions 24a, 24b of the projection receivers 23a, 23b, to connect the coil members 2a, 2b.

As shown in FIG. 3, each hook-shaped projection 20a, 20b comprises a pair of arms 21 with a space therebetween, and hook-shaped portions 22 connected to their tip ends. A pair of arms 21 and a pair of hook-shaped portions 22 are respectively linearly symmetric with respect to a centerline of the space, though they may have different shapes. The hook-shaped projections 20a, 20b and the projection receivers 23a, 23b are not restricted to have the depicted shapes as long as they are engageable.

Reinforcing Portion

As shown in FIG. 4, there is a gap 26a, 26b between an inner surface of a thin portion of the resin case 3 (4a, 4b) and an outer surface of the magnetic core 250, on the end side of the magnetic core 250. In the figure, the gaps 26a, 26b are marked by black for clarity. As shown in FIG. 3, each projection plate 25a, 25b is a thin plate portion extending from the resin case 3 in the assembling direction of the coil members, slightly receding from an outer surface of the resin case 3. Each projection plate 25a, 25b is in a U shape when viewed in the assembling direction, such that it partially surrounds the magnetic core 250. A projection plate of one coil member can be inserted into the gap of the other coil member. Namely, the projection plate 25a is inserted into the gap 26a, and the projection plate 25b is inserted into the gap 26b, between the opposing coil members. In a state where the coil members 2a, 2b are assembled, abutting portions of the opposing magnetic cores 250 are surrounded by the projection plates 25a, 25b of the reinforcing parts, providing high strength to the connecting portions. Before the coil members 2a, 2b are adhered, the movement of the coil members can be limited in the assembling direction. As a result, cooperating with the connecting parts, the disconnection of the coil members 2a, 2b can be prevented during production.

The connection of the coil members 2a, 2b will then be explained. The hook-shaped portions 22 of the hook-shaped projections 20a, 20b of the connecting parts are put near the projection receivers 23a, 23b, and then inserted into the hollow portions 24a, 24b of the projection receivers 23a, 23b. The insertion elastically flexes the arm portions 21 to reduce their space, so that hook-shaped portions 22 enter the hollow portions 24a, 24b.

After the hook-shaped portions 22 pass through the hollow portions 24a, 24b, the space between the arm portions 21 expands to the original one, resulting in latching to connect the coil members 2a, 2b. Because the total width of the arm portions 21 including their space is slightly smaller than the width of each hollow portion 24a, 24b, the coil members 2a, 2b can be connected with loose engagement.

The hook-shaped projections 20a, 20b of the connecting parts are so long as to extend beyond the end surfaces of the projection plates 25a, 25b of the reinforcing parts. Accordingly, to assemble the coil members 1, the projection plates 25a, 25b are inserted into the gaps 26a, 26b of the reinforcing parts, after the hook-shaped portions 22 of the hook-shaped projections 20a, 20b of the connecting parts are inserted into the hollow portions 24a, 24b of the opposing projection receivers 23a, 23b. Using the reinforcing parts as guides for loosely inserting the connecting parts, the projection plates are inserted into the gaps of the reinforcing parts founed in the connecting portions, so that the horizontal and vertical, relative positions of the magnetic cores 250 in two core members 2a, 2b can be precisely and easily set to abut the end surfaces of the magnetic cores 250 for assembling, with high precision and little unevenness.

In the connecting portions of the coil members 2a, 2b, the hook-shaped projection 20a, 20b and the projection receiver 23a, 23b of each connecting part are positioned, such that the hook-shaped projection 20a, 20b is on one side of the magnetic core 250, while the projection receiver 23a, 23b is on the other side, when viewed in the assembling direction. Further, the projection plate 25a of the reinforcing part is on the side of the projection receiver 23a of the connecting part, while the projection plate 25b is on the side of the projection receiver 23b. The gap 26a of the reinforcing part is on the side of the hook-shaped projection 20a of the connecting part, while the gap 26b is on the side of the hook-shaped projection 20b.

The hook-shaped projections 20a, 20b and projection receivers 23a, 23b of the connecting parts of the coil members 2a, 2b are at 180°-inversed positions between one connecting portion and the other connecting portion. With such structure, the resin cases constituting a pair of coil members can have the same shape, resulting in the reduced number of parts, thereby lower production cost.

As shown in FIG. 5, end portions of the magnetic cores 250 slightly project at the connecting portions of the resin case 3 in the assembled coil members, such that the end surfaces of the magnetic cores 250 can abut each other. The projecting width D is preferably 0.5 mm or less. The reinforcing parts restrict the moving directions of the coil members, and the loose fitting of the connecting parts enables the use of common resin cases without necessitating different resin cases, even when the uneven sizes of the magnetic cores 250 provide different projecting widths D between the coil members, and even when an insulating spacer such as a resin film, a ceramic or oil paper, etc. is placed between the end surfaces of the magnetic cores 250 to constitute a magnetic gap. Also, an annular coil device whose gap may vary from 0 can be easily obtained regardless of a combination of coil members 2a, 2b.

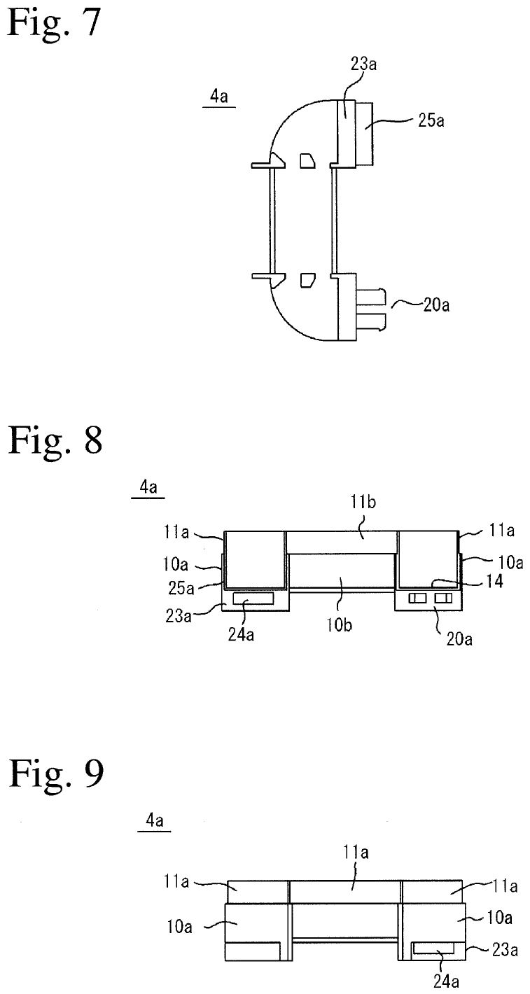

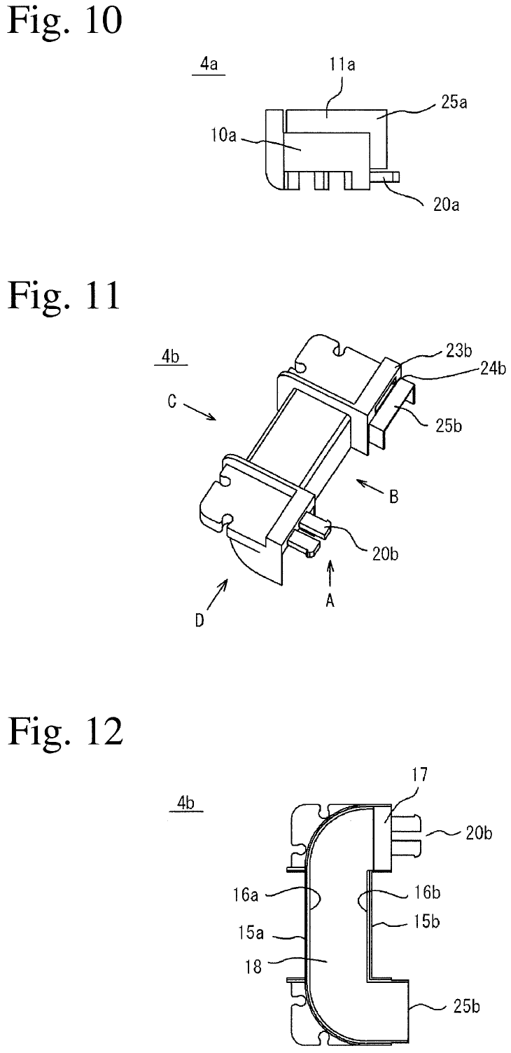

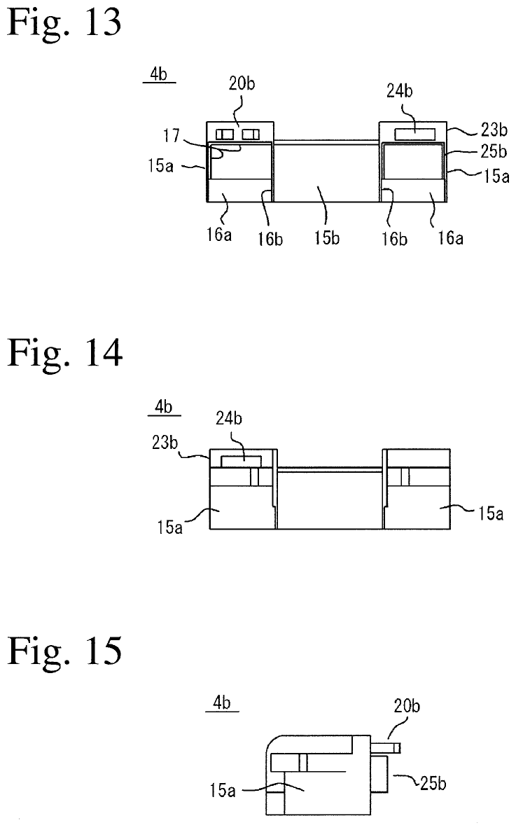

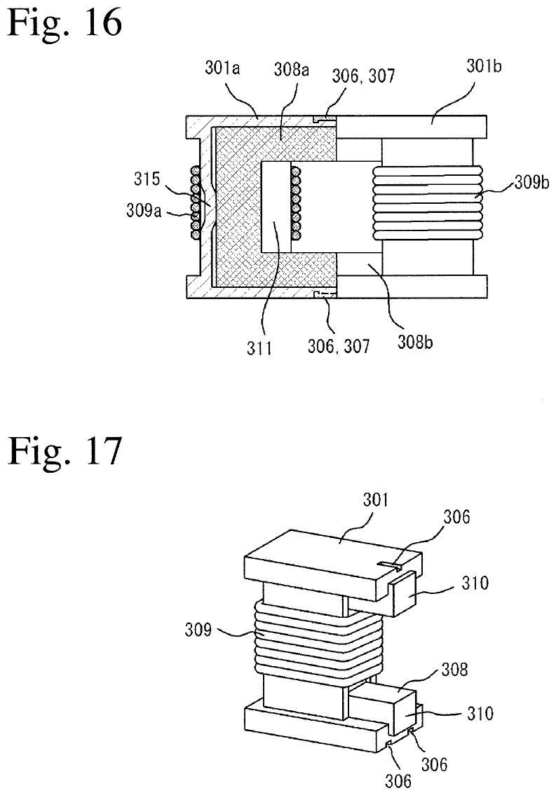

The structure of the resin case will be explained in detail referring to the drawings. FIGS. 6-15 show the structure of the resin case, FIG. 6 being a perspective view showing one case member (first case member), FIG. 7 being a bottom view showing the first case member in a direction A, FIG. 8 being a right side view showing it in a direction B, FIG. 9 being a left side view showing it in a direction C, FIG. 10 being a front view showing it in a direction D, FIG. 11 being a perspective view showing the other case member (second case member), FIG. 12 being a bottom view showing the second case member in a direction A, FIG. 13 being a right side view showing it in a direction B, FIG. 14 being a left side view showing it in a direction C, and FIG. 15 being a front view showing it in a direction D.

As described above, the resin case is constituted by two case members, a first case member 4a and a second case member 4b. FIGS. 6-10 show the structure of the first case member. The first case member 4a receiving the magnetic core has a basic structure comprising a U-shaped space 13 having a bottom, from which an outer wall 10a and an inner wall 10b integrally extend upward. One end portion of the first case member 4a is provided with a projection receiver 23a of the connecting part and a projection plate 25a of the reinforcing part, while the other end portion is provided with a hook-shaped projection 20a and a receded step 14 for constituting the gap 26a of the reinforcing part. The outer wall 10a and inner wall 10b are provided with outer steps 11a, 11b for receiving the end portions of the second case member 2b. The outer steps 11a, 11b are continuous with the projection plate 25a, and their upper ends are connected at the same height.

FIGS. 11-15 show the structure of the second case member in detail. Like the first case member 4a, the second case member 4b has a basic structure comprising a U-shaped space 18 having a bottom, from which an outer wall 15a and an inner wall 15b integrally extend downward. The second case member 4b is also provided with a connecting part and a reinforcing part at both ends. One end portion is provided with a projection receiver 23b of the connecting part and a projection plate 25b of the reinforcing part, while the other end portion is provided with a hook-shaped projection 20b and a receded step 17 for constituting the gap 26b of the reinforcing part. Expanded corner portions are provided with four notches supporting end portions of the coil. The outer wall 15a and the inner wall 15b are provided with inner steps 16a, 16b. The walls are thin on the opening side of the bottomed space 18 and thick on the bottom side, to receive the end portions of the first case member 4a.

The positioning of the case members is conducted by combining the outer steps 11a, 11b of the first case member 4a with the inner steps 16a, 16b of the second case member 4b. Because the steps of the case members 4a, 4b are fit without gaps, the assembled resin case 3 has substantially no steps on its outer and inner surfaces.

The resin case is preferably formed by resins having excellent insulation, heat resistance, flexibility and moldability, specifically plastics such as polypunylene sulfide, polyethylene terebuthalate, ABS resins, engineering plastics, etc.

Because the annular assembling of divided magnetic cores easily provides a coil device with improved insulation between the coils and the magnetic cores while preventing easy separation of the coil members, the present invention can be applied to various coil devices.

1. A coil device comprising a pair of annularly assembled coil members each comprising a coil arranged on a resin case containing a U-shaped magnetic core;
each of said coil members having connecting portions on both end sides of said magnetic core;
each of said connecting portions having a connecting part and a reinforcing part;
said reinforcing part being constituted by a gap between an inner wall of the resin case and an outer wall of the magnetic core, and a projection plate extending in the assembling direction of the coil members, a projection plate of one coil member being insertable into the gap of the other coil member; and
said connecting part comprising a hook-shaped projection extending in said assembling direction and a projection receiver, the hook-shaped projection of one coil member being loosely fittable into the projection receiver of the other coil member.

2. The coil device according to claim 1, wherein the connecting portion of each coil member has a hook-shaped projection of said connecting part on one side of said magnetic core, and said projection receiver on the other side, when viewed in the assembling direction, and further has a projection plate of said reinforcing part on the side of the projection receiver of said connecting part, and said gap on the side of the hook-shaped projection of said connecting part.

3. The coil device according to claim 2, wherein the positional relation between the hook-shaped projection and projection receiver of the connecting part in one connecting portion of said coil member is 180° inverse to that in the other connecting portion.

4. The coil device according to claim 1, wherein when the coil members are assembled, abutting portions of the opposing magnetic cores are surrounded by the projection plates of said reinforcing parts.

5. The coil device according to claim 1, wherein said hook-shaped projection of the connecting part has two arms, each arm having a hook-shaped portion at its tip end.

6. The coil device according to claim 1, wherein said resin case is constituted by two assembled case members, each of said case members receiving said magnetic core in its bottomed space.

7. The coil device according to claim 1, wherein said resin case has flanges for positioning said coil.
